(19) United States
(12) Patent Application Publication
(10) Pub. No.: US 2021/0027325 A1
(43) Pub. Date: Jan. 28, 2021

(54) Systems and Methods for Automated Transaction Analysis

(71) Applicant: JPMorgan Chase Bank, N.A., New York, NY (US)

(72) Inventors: Nicholas M. Lore, Pearl River, NY (US); Raj Mehta, San Francisco, CA (US)

(21) Appl. No.: 15/160,237

(22) Filed: May 20, 2016

(51) Int. Cl. G06Q 30/02

(52) U.S. Cl. CPC G06Q 30/0215; G06Q 30/0222

(57) ABSTRACT

Systems and methods for automated transaction analysis are disclosed. In one embodiment, a method for transaction evaluation may include (1) a computer processor receiving an identification of a plurality of completed transactions that were completed using a first transaction account; (2) the computer processor receiving an identification of a first benefit earned based on the first transaction account; (3) the computer processor receiving a plurality of parameters for a second transaction account; (4) the computer processor simulating a usage of the second transaction account by applying the plurality of parameters for the second transaction account to the completed transactions; (5) the computer processor identifying a second benefit earned based on the simulation; and (6) the computer processor outputting the results of the simulation comprising a comparison of the first benefit to the second benefit.

### BACKGROUND OF THE INVENTION

### 1. Field of the Invention

The present disclosure generally relates to systems and methods for automated transaction analysis.

### 2. Description Of The Related Art

Consumers are presented with a variety of credit cards that offer different incentives for use. For example, some credit cards offer cash back on purchases; others offer airline miles, free checked bags, priority boarding, etc. Still others offer low interest rates. Others have no annual fee. Complicating matters is the fact that customers have different objectives for their credit card use, including maximizing cash back, airline miles, minimizing finance charges, etc.

### SUMMARY OF THE INVENTION

Systems and methods for automated transaction analysis are disclosed. In one embodiment, a method for transaction evaluation may include (1) a computer processor receiving an identification of a plurality of completed transactions that were completed using a first transaction account; (2) the computer processor receiving an identification of a first benefit earned based on the first transaction account; (3) the computer processor receiving a plurality of parameters for a second transaction account; (4) the computer processor simulating a usage of the second transaction account by applying the plurality of parameters for the second transaction account to the completed transactions; (5) the computer processor identifying a second benefit earned based on the simulation; and (6) the computer processor outputting the results of the simulation comprising a comparison of the first benefit to the second benefit.

In one embodiment, the method may further include the computer processor recommending one of the first transaction account and the second transaction account.

In one embodiment, the plurality of transactions may include at least one purchase with the first transaction account, at least one payment to the first transaction account, etc. The plurality of completed transactions may be received from a third party.

In one embodiment, the plurality of parameters may include a rate for earning the second benefit.

In one embodiment, the first benefit may include a reward earned for the transactions conducted with first transaction account.

In one embodiment, the first benefit and the second benefit may include airline miles, points, cash back, combinations thereof, etc.

In one embodiment, the plurality of parameters may include an interest rate.

In one embodiment, the second benefit may include a discount based on a preferred relationship with a merchant.

In one embodiment, the computer processor may select the second transaction account based on the completed transactions.

In one embodiment, the first transaction account may be cobranded with a first merchant in a first industry, and the second transaction account may be cobranded with a second merchant in a second industry.

In one embodiment, the method may further include the computer processor receiving an account number for the second transaction account; the computer processor identifying a merchant with a recurring transaction from the completed transactions; and the computer processor providing the merchant with the account number for the second transaction account.

In one embodiment, the method may further include the computer processor identifying a membership with a merchant from the completed transactions; the computer processor determining that the completed transactions do not include any other transactions with the merchant; and the computer processor cancelling the membership with the merchant.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for automated transaction analysis according to one embodiment.

FIG. 2 depicts a method for i automated transaction analysis according to one embodiment.

FIG. 3 depicts a method for automated transaction analysis according to another embodiment.

### DETAILED DESCRIPTION OF PREFERRED EMBODIMENTS

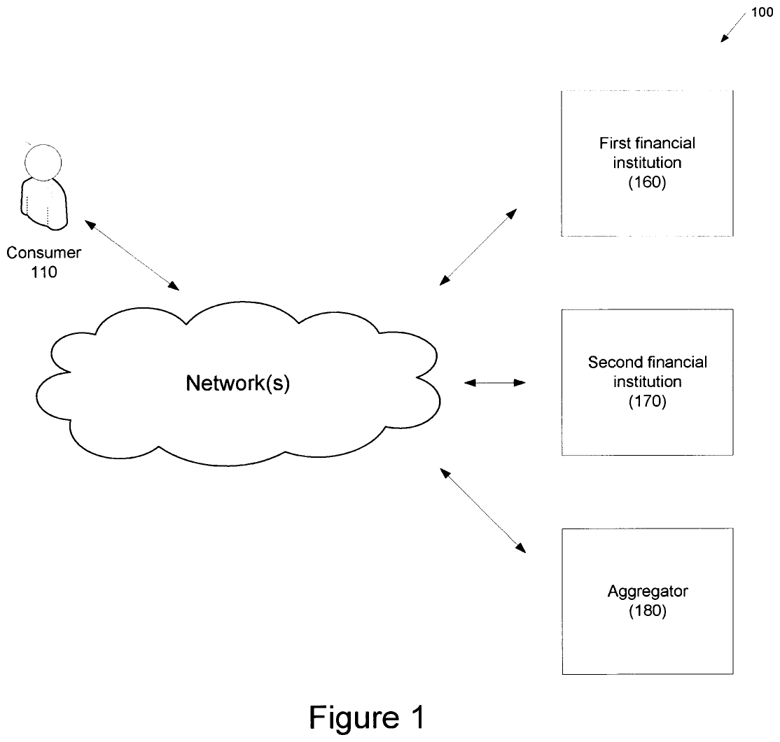

Several embodiments of the present invention and their advantages may be understood by referring to FIGS. 1-3.

Embodiments disclosed herein are generally directed to systems and methods for automated transaction analysis.

Referring to FIG. 1, a system for intelligent credit card selection is disclosed according to one embodiment. System 100 may include customer 110, network(s) 150, first financial institution 160, second financial institution 170, and aggregator 180.

In one embodiment, first financial institution 160 and second financial institution 170 may issue financial instruments, such as credit cards. Although only two financial institutions 160 and 170 are depicted in FIG. 1, it should be recognized that a greater number may be provided as is necessary and/or desired.

In one embodiment, aggregator may be a financial information aggregator, such as Mint, Quicken, etc.

Network(s) 150 may be any suitable communication network, payment network (e.g. open loop, closed loop), combinations thereof, etc.

In one embodiment, consumer 110 may use an electronic device (e.g., smartphone, tablet computer, notebook computer, desktop computer, internet appliance, kiosk, ATM, etc.) that may execute a computer program or application. In one embodiment, the electronic device may include an electronic wallet, payment application, etc. that may store and/or access payment credentials.

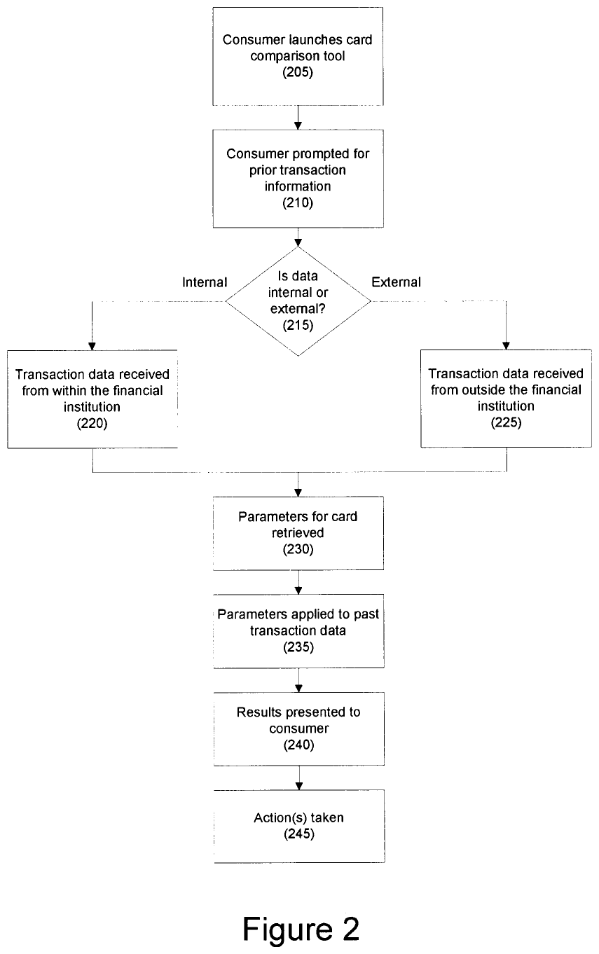

Referring to FIG. 2, a method for automated transaction analysis is disclosed according to one embodiment. In step 205, a consumer may launch a credit card selection tool. The card selection tool may be executed by a mobile electronic device (e.g., smartphone, tablet computer, etc.), a desktop computer, a kiosk, an ATM, etc.

In one embodiment, the consumer may access the tool via a financial institution with which the consumer already has a credit card account, such as by using the financial institution's website, application, ATM, etc. In another embodiment, the consumer may launch the credit card selection tool via a financial institution with which the consumer does not have a credit card account. In still another embodiment, the consumer may access the tool via a third party, such as an aggregator, a partner of a financial institution, etc.

In one embodiment, the credit card selection tool may be used by the consumer to identify one or more credit cards that may provide the rewards, incentives, etc. that the consumer desires. In another embodiment, the credit card selection too may be used by the financial institution to offer a credit card that may provide better incentives, rewards, etc. than the current card that the customer possesses.

In one embodiment, the consumer may identity one or more card parameters that he or she would like to maximize or minimize. In one embodiment, the consumer may identify the parameter in a drop-down box, and may select whether to maximize, minimize, or optimize. For example, the consumer may identify “airline miles” as a parameter to maximize. In another embodiment, the consumer may seek to minimize the interest rate. In still another embodiment, the consumer may seek to maximize cash back and not pay an annual fee. Any combination of parameters may be identified by the consumer as is necessary and/or desired.

In one embodiment, the card selection tool may identify the one or more additional credit cards by analyzing the past transaction history below. For example, if the customer is a frequent airline traveler, the card selection tool may identify a credit card that is cobranded with an airline.

In one embodiment, the additional credit card may be cobranded with a merchant that is in a different industry than the current credit card.

In step 210, the consumer may be prompted to provide past transaction data. In one embodiment, the consumer may identify a current credit card account and, if necessary, provide log-in credentials for the credit card selection tool to access the transactions. In another embodiment, the consumer may identify a file that may include the data. In still another embodiment, the consumer may provide credentials for the credit card access tool to access the data via an aggregator. In still another embodiment, the consumer may manually enter past credit card transactions. In another embodiment, the consumer may provide transactions in scans or images of past credit card statements.

Any other way of providing past credit card transaction data, and combinations thereof, may be used as necessary and/or desired.

In one embodiment, the past transaction data may include credit card transactions, payments, credits, rewards/incentives earned, rewards/incentives applied, etc.

In step 215, the card comparison tool may determine whether the data is internal (e.g., internal to financial institution hosting or associated with the card comparison tool, provided by the customer, etc.) or if it is external (e.g., from a financial institution not associated with the card comparison tool, from an aggregator, from an entity that may require login credentials, etc.). If the data is internal, the card comparison tool may retrieve or otherwise receive the past transaction data in step 220. If the data is external, the card comparison tool may request credential(s) to access the data from the external source(s) and then receive the data.

In one embodiment, a combination of external sources may be used. For example, data from one or more external financial institutions may be received from an aggregator or a plurality of aggregators.

In step 230, parameters associated with one or more credit card may be retrieved. For example, cost parameters (e.g., annual fees, minimum payments, interest rates, etc.), rewards (e.g., cash back, reward points, discounts, etc.), benefits, (e.g., free/discounted checked bags, free/discounted club memberships, etc.), and other parameters may be retrieved. In one embodiment, the parameters may be retrieved from the issuing financial institution, from promotional materials, from the consumer, etc.

In one embodiment, the consumer may specifically identify the one or more credit card of interest. In another embodiment, the financial institution may identify other credit cards it issues. In another embodiment, the financial institution may identify competitor's credit cards. In still another embodiment, a third party may identify popular cards, cards that are likely to meet the consumer's objectives, etc. for the consumer.

In step 235, the parameter(s) may be applied to the past transactions. In one embodiment, the consumer may identify certain transactions to exclude as necessary and/or desired.

In one embodiment, the application of the parameters to the past transaction may approximate the results had the credit card of interest been used to conduct the transactions.

In step 240, the credit card selection tool may present the results to the consumer. In one embodiment, the rewards/incentives may be provided, and may be compared to a current credit card, to other credit cards, etc. In one embodiment, the credit cards may be ranked based on their rewards.

In one embodiment, the credit card selection tool may provide a detailed analysis of the cost associated with the credit card(s).

In step 245, one or more actions may be taken. In one embodiment, the consumer may select a credit card based on the results, may stay with the current credit card, etc. For example, in one embodiment, the consumer may decide to apply for the card of interest, or any other card presented by the card comparison tool. The consumer may be prompted to complete an application for that credit card.

In another embodiment, should the consumer decide to apply for a new credit card, payment information (e.g., online bill payment information, etc.) may be automatically transferred to the new account. Examples of such are disclosed in U.S. Pat. Nos. 7,848,974; 7,844,519; 8,055,564; 8,392,305; 8,660,926; and 8,793,174. The disclosures of each of these patents is hereby incorporated, by reference, in its entirety.

In another embodiment, the consumer may also have a token provisioned for a payment application, mobile wallet, etc. Examples are disclosed in U.S. Patent Application Ser. Nos. 62/312,204; 62/149,304; and 15/131,979, the disclosures of which are hereby incorporated, by reference, in their entireties.

In one embodiment, the tool may determine a total spend based on the past transactions, and may recommend a specific credit limit for a new card. In addition, if the customer does not plan on closing an existing account, and the account is issued by the same issuer, the tool may recommend a lower credit limit on the old account(s) to incentivize transactions with the new account.

In another embodiment, the tool may identify merchants with which the issuer of the card of interest may have a special relationship that may benefit the consumer, such as greater reward points, incentives, lower prices, etc. The card comparison tool may then recommend these merchants to the consumer.

In another embodiment, the card comparison tool may identify merchants with which the consumer may have payment information on file, recurring payments, etc., and may present these to the user. In one embodiment, the credit card comparison tool may provide new credit card information for the credit card of interest to these merchants if authorized by the consumer.

An example of such is disclosed in U.S. patent application Ser. No. 15/644,634, the disclosure of which is hereby incorporated by reference in its entirety.

In one embodiment, the credit card tool may forecast or approximate at least one benefit of using the credit card of interest. For example, the credit card tool may approximate the reward points, reward dollars, incentives, etc. that the consumer may receive using the credit card of interest in the future. In one embodiment, the issuer of the credit card of interest may guarantee a certain amount of reward points, reward dollars, incentives, etc. should the consumer use the credit card of interest in the same manner as in the past. If the consumer does not receive the guaranteed minimum, the issuer may provide reward points of another incentive to compensate for the difference.

Any other suitable action may be taken as is necessary and/or desired.

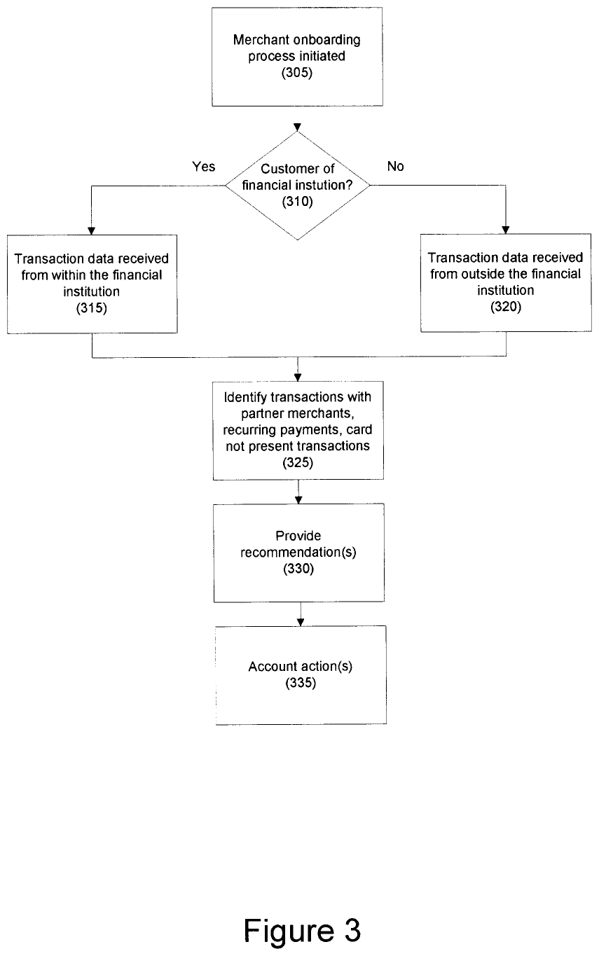

Referring to FIG. 3, a method for automated transaction analysis is disclosed according to another embodiment. In step 305, the merchant onboarding process may be initiated. The merchant onboarding process may be used by consumers that already possess the credit card, and it may be conducted periodically or as necessary and/or desired. It may also be used by consumers that have applied for a new credit card as part of the post-approval process.

For example, the process may be initiated by a consumer using a mobile application executed by a mobile electronic device, on a webpage, at a kiosk, at an ATM, etc. In another embodiment, a financial institution that issued the financial instrument being evaluated may initiate the review.

In step 310, if the consumer is a customer of the financial institution, in step 315, past transaction data for the customer using one or more transaction accounts may be retrieved. In one embodiment, the transactions for a predetermined period (e.g., 1 year, 6 months, 1 month, etc.) may be retrieved.

If the consumer is not a customer of the financial institution that is issuing the financial instrument, in step 320, the consumer may provide past transaction data as described above.

In step 325, the past transaction data may be evaluated to identify specific transactions and/or merchants. For example, transactions that the consumer has had with merchants having relationships with the financial institution may be identified. This may include merchants that may provide discounts, rebates, additional reward points, or any other incentive to the consumer.

The past transaction data may be evaluated to identify transactions in with the merchant may store financial account information. This may include, for example, card not present (CNP) transactions.

The past transaction data may be evaluated to identify recurring payments with certain merchants. This may include, for example, transactions with the same merchant that occur periodically (e.g., monthly) or pseudo-periodically (e.g., the first business day of each month, etc.), transactions with the same merchant having approximately the same amount, transactions with service providers/utilities (e.g., cellular phone company, electric company, etc.), etc.

The past transaction data may be evaluated to identify any subscriptions or memberships that the consumer may have (e.g., with Amazon.com, bookstores, wholesale warehouses, etc.). In one embodiment, the past transaction data may be analyzed to determine if the consumer has conducted any transactions with the merchant with which the consumer has a subscription, and may provide recommendations (e.g., cancel subscription) if no transaction data exists.

Based on the evaluation(s), in step 330, recommendation(s) may be provided to the consumer. In one embodiment, a recommendation regarding conducting a transaction with the merchant that provides benefits to cardholders may be provided. In another embodiment, a recommendation to provision a merchant-specific token to a recurring payment merchant may be provided. In another embodiment, a recommendation to cancel a subscription with a merchant that the consumer has not conducted a transaction with may be provided.

Any other suitable recommendation(s) may be provided as is necessary and/or desired.

In step 335, if the consumer is opening a new account, the issuer may provide new account information to merchants that have been identified as having recurring payments. In one embodiment, the issuer may require specific authorization from the customer to provide the new financial instrument information to the merchant.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for transaction evaluation, comprising:
in an information processing device comprising at least one computer processor;
receiving, from a user, a request for a transaction evaluation;
receiving, from the user, a selection of one or more parameters that the user would like to optimize, wherein the parameters include airline miles, cash back, interest rate, and annual fee;
receiving, from the user, an identification of one or more user accounts at a financial institution and credentials for each of the one or more user accounts;
receiving, from the user, an identification of one or more credit card accounts of interest, said interest relating to the user's selection of one or more parameters;
receiving, from the financial institution's transaction database, a plurality of completed transactions that were conducted using the one or more user accounts;
the computer processor receiving an identification of benefits earned based on the completed transactions with the one or more user accounts;
receiving a plurality of reward-earning parameters for each of the one or more credit card accounts of interest identified by the user;
identify potential transaction account benefits for each of the one or more credit card accounts of interest identified by the user by simulating the completed transactions with each of those credit card accounts with the plurality of reward-earning parameters;
identify, by the processor, one or more credit card accounts associated with the financial institution that were not identified by the user;
identify potential transaction account benefits for each of the one or more credit card identified by the processor by simulating conducting the completed transactions with each of those credit card accounts;
outputting a comparison of the benefits earned for the one or more user accounts to both the one or more credit card accounts of interest identified by the user and the one or more credit card accounts identified by the processor, wherein the comparison includes a ranking of the one or more credit card accounts of interest identified by the user and the one or more credit card accounts identified by the processor;
presenting the user with an option to select amongst the one or more credit card accounts of interest identified by the user and the one or more credit card identified by the processor;
receiving a selection of one of the one or more credit card accounts of interest identified by the user and the one or more credit card identified by the processor; and
presenting, in response to the selection of one of the one or more credit card identified by the processor, an application for the selected credit card identified by the processor.

2. The method of claim 1, further comprising:
recommending one of the one or more credit card accounts of interest identified by the user and the one or more credit card accounts identified by the processor.

3. The method of claim 1, wherein the plurality of transactions comprises at least one purchase with the one or more user accounts.

4. The method of claim 1, wherein the plurality of transactions comprises at least one payment to the one or more user accounts.

5. The method of claim 1, wherein the plurality of completed transactions are received from a third party.

6. The method of claim 1, wherein the plurality of reward-earning parameters comprise a rate for earning the second benefit.

7. The method of claim 1, wherein the one or more user accounts benefits comprise at least one reward earned for the transactions conducted with the one or more user accounts.

8. (canceled)

9. The method of claim 1, wherein the plurality of reward-earning parameters comprise an interest rate.

10. The method of claim 1, wherein the potential transaction account benefits for each of the one or more credit card accounts identified by the user include a discount based on a preferred relationship with a merchant.

11. The method of claim 1, wherein the computer processor selects the one or more credit card accounts associated with the financial institution based on the completed transactions.

12. The method of claim 1, wherein the one or more credit card accounts of interest identified by the user is cobranded with a first merchant in a first industry, and the one or more credit card accounts identified by the processor is cobranded with a second merchant in a second industry.

13. (canceled)

14. The method of claim 1, further comprising:
identifying a membership with a merchant from the completed transactions;
determining that the completed transactions do not include any other transactions with the merchant; and
cancelling the membership with the merchant.

15. The method of claim 1, further comprising:
forecasting a use of the one or more credit card accounts identified by the processors.

16. The method of claim 11, wherein the one or more credit card accounts identified by the processors is selected based on a merchant for at least one of the completed transactions.

17. The method of claim 1, further comprising:
receiving a selection of a reward-earning parameter; and
identifying the one or more credit card accounts identified by the processors based on the selected reward-earning parameter.

18. The method of claim 1, further comprising:
provisioning a token for the one or more credit card accounts identified by the processor to a digital wallet executed by the electronic device.

19. The method of claim 1, further comprising:
automatically transferring payment information to the one or more credit card accounts identified by the processor.
